(19) United States
(12) Patent Application Publication
(10) Pub. No.: US 2017/0370482 A1
(43) Pub. Date: Dec. 28, 2017

(54) SUB-PLATE MOUNTED VALVE

(71) Applicant: AXON ENERGY PRODUCTS UK LTD, Gateshead (GB)

(72) Inventors: Jonathan Lynch, London (GB); Paul Campbell, Durham (GB)

(21) Appl. No.: 15/543,737

(22) PCT Filed: Jan. 15, 2015
(86) PCT No.: PCT/GB2015/050081

§ 371 Date: Jul. 14, 2017

(51) Int. Cl. F16K 11/044; E21B 34/04; E21B 33/064; F16K 31/163; F16K 31/122; F15B 13/04

(52) U.S. Cl. CPC F16K 11/044; F16K 31/1635; F16K 31/1221; E21B 34/04; E21B 33/064; F15B 13/0402; F16K 31/1223

(57) ABSTRACT

A sub-plate mounted valve for installation in a sub-plate or manifold for controlling hydraulic systems, such as subsea blowout preventers. A spool (123) disposed within the valve is movable between an open position in which fluid flow is permitted from a supply port (108) of the manifold to a function port (106) of the manifold, and a closed position in which fluid flow is permitted between a return port (110) of the manifold and the function port (106). The spool (123) is moved between the open and the closed position by supplying pressurized fluid to a piston (126) disposed on the outside surface of the spool. One or more springs (130) may also act on the piston to bias the spool into the open or the closed position. To facilitate proper alignment of the valve within the manifold, the valve may be rotated within the manifold to align indicators (450, 452) corresponding to particular features of the manifold and the valve.

### TECHNICAL FIELD

The present disclosure relates to sub-plate mounted valves and manifolds and sub-plate containing sub-plate mounted valves. Sub-plate mounted valves are generally used to control flow of pressurized fluids in hydraulic systems, including subsea blow out prevention systems.

### BACKGROUND

Subsea hydrocarbon recovery systems can include a blowout preventer for sealing, controlling, and monitoring well operations. Control and operation of the blowout preventer and related equipment is typically achieved through a system of hydraulic actuators controlled by a manifold or sub-plate having multiple control valves. Among the control valves commonly used in such systems are sub-plate mounted valves.

One or more sub-plate mounted valves may be installed directly into the manifold or sub-plate. The manifold or sub-plate defines at least three ports: a function port, a supply port, and a return port. Generally, the supply port provides high pressure fluid to control or actuate hydraulic equipment connected to the function port while the return port provides a means for venting or otherwise relieving pressure within the hydraulic system. Each valve is operable between at least two positions. In the first position, the valve permits fluid flow from the supply port to the function port. In the second position, the valve relieves pressure in the hydraulic circuit by permitting flow through a return loop or venting the fluid.

Subsea operations continue to progress into deeper and harsher oceanic environments and there is a growing need for equipment capable of operating effectively and efficiently under such conditions. The efficiency of a valve is highly dependent on the flow path through the valve because restrictions and tortuous redirections within the valve cause pressure losses. As operating pressure increases, the losses associated with an inefficient valve can be amplified. As a result, systems including inefficient valves may require pumps and other equipment to be oversized to account for any losses and to ensure that adequate fluid pressure is maintained. Due to the demands of the subsea environment such oversizing may require stronger materials, improved seals, and other significant and costly equipment upgrades.

In addition to issues regarding flow efficiency, the overall costs of designing, constructing, and installing a piece of subsea equipment can be significantly impacted by the size of components included in the equipment. For example, if a footprint of a given piece of equipment is limited, significant design efforts may be required to ensure that all components of the equipment fit within the footprint. Even absent stringent footprint requirements, larger equipment can significantly increase manufacturing, shipping, handling, and installation costs of the equipment.

In light of the above, there is demand for a compact and efficient sub-plate mounted valve.

### SUMMARY

Embodiments of the present disclosure are directed to a sub-plate mounted valve having improved flow characteristics and a compact design, and a manifold including such a sub-plate mounted valve.

In accordance with the present disclosure, the sub-plate mounted valve includes a valve body containing a pilot-driven spool. By selectively supplying pressure to a piston disposed on the spool, the spool is movable within the body between an open and closed position. In the open position, fluid flow is permitted between a supply port and a function port of a manifold or sub-plate in which the valve is installed. In the closed position, flow is permitted between a return port and the function port. In addition to the piston, the valve may include one or more springs for biasing the spool in one of the open and closed positions.

Sub-plate mounted valves according to this disclosure may also include features to permit proper alignment of the sub-plate mounted valve when installed in a manifold or sub-plate. Specifically, the sub-plate mounted valve may be rotated in place after insertion into a valve pocket of a manifold or sub-plate to properly align holes of the valve with corresponding ports of the manifold or sub-plate. The alignment process may be facilitated by indicators located on the manifold and valve corresponding to the ports and holes, respectively. Once aligned, a locking plate may be installed to prevent any rotational movement of the valve that would otherwise lead to misalignment.

These and various other features and advantages will be apparent from a reading of the following detailed description and drawings along with the appended claims.

### BRIEF DESCRIPTION OF THE DRAWINGS

Embodiments and advantages of the present disclosure may be best understood by one of ordinary skill in the art by referring to the following description and accompanying drawings. In the drawings:

FIGS. 1A and 1B are cross-sections of an embodiment of a sub-plate mounted valve according to this disclosure in the closed and the open positions, respectively.

FIG. 2 is an isometric view of an embodiment of a sub-plate mounted.

FIG. 3 is a cutaway view of an embodiment of a sub-plate mounted valve installed within a manifold.

FIG. 4 is a detailed view of the locking plate and valve cap of a sub-plate mounted valve according to one embodiment.

FIGS. 5A and 5B are cross-sections of another embodiment of a sub-plate mounted valve according to this disclosure in the closed and the open positions, respectively.

### DETAILED DESCRIPTION

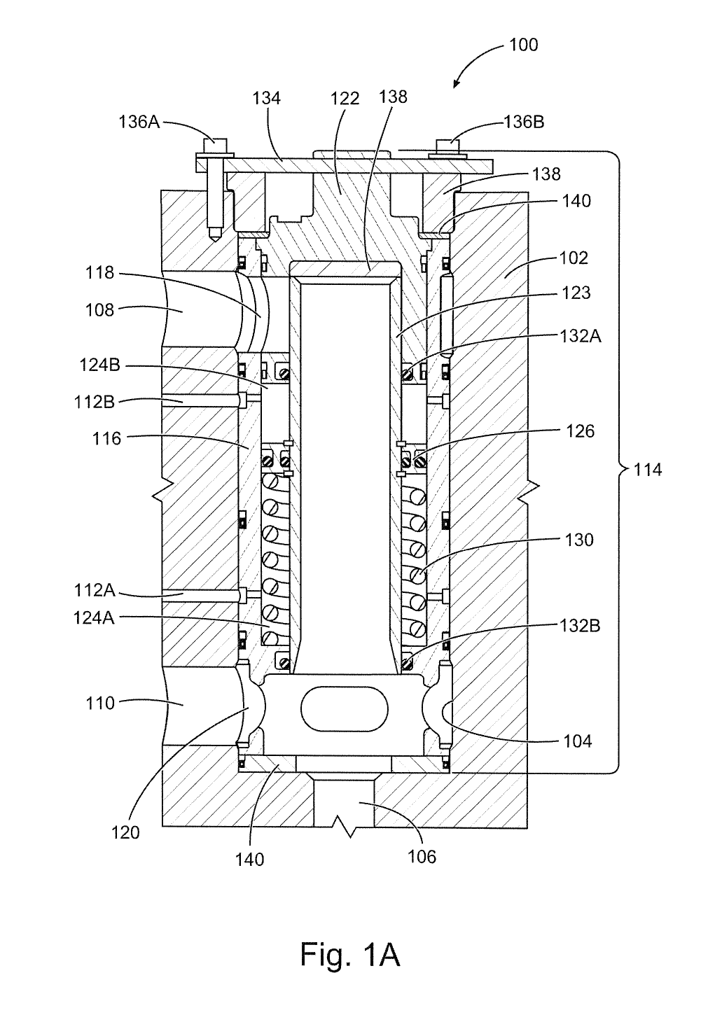

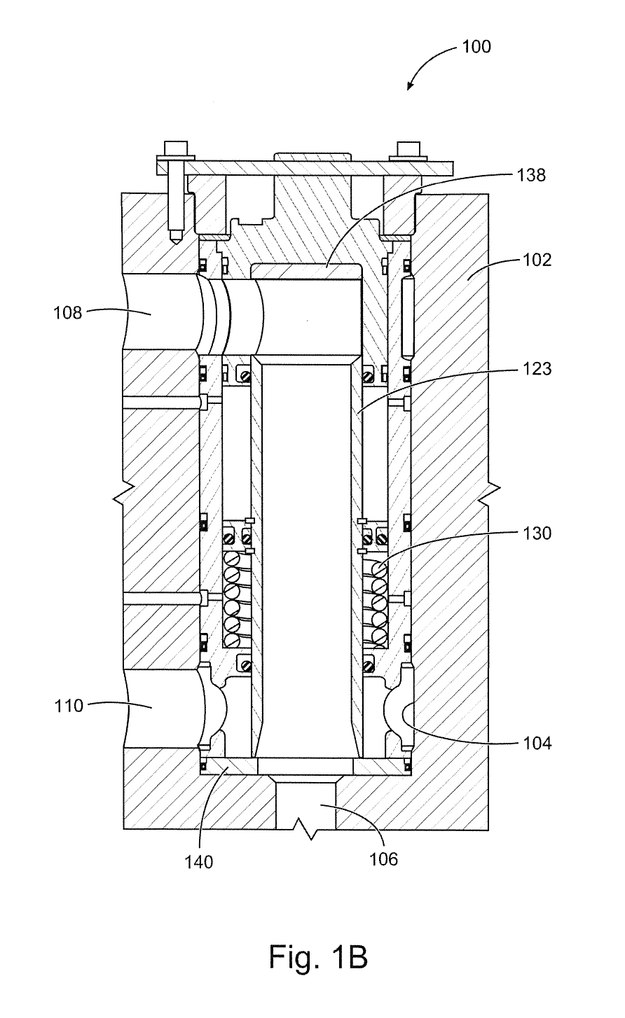

FIG. 1A is a cross-sectional view of a sub-plate mounted valve 100 according to one embodiment of the present disclosure. The valve 100 is depicted as being installed in a manifold 102. Alternatively, the valve 100 may be installed into a sub-plate.

As shown in FIG. 1A, the manifold 102 is machined to have a valve pocket 104 to receive the valve 100 and a series of ports for directing fluid through the valve 100. The ports include a function port 106, a supply port 108 through which a fluid is provided, a return port 110, and a pair of pilot ports 112A, 112B. The function port 106 is connected to a pneumatic or hydraulic circuit for performing a particular function when pressurized fluids are supplied to the circuit. As depicted in FIG. 1, the supply port 108 and the return port 110 can be located on the same side of the valve pocket 104. In other embodiments, the supply port 108 and the return port 110 may be located on different sides of the valve pocket 104. Similarly, the supply port 108 is depicted in FIG. 1A as being above the return port 110, however in other embodiments, the position of the supply port 108 and the return port 110 may be switched such that the return port 110 is located above the supply port 108.

According to one embodiment, the valve 100 includes a valve body 114 comprising a cage 116 and a valve cap 122.

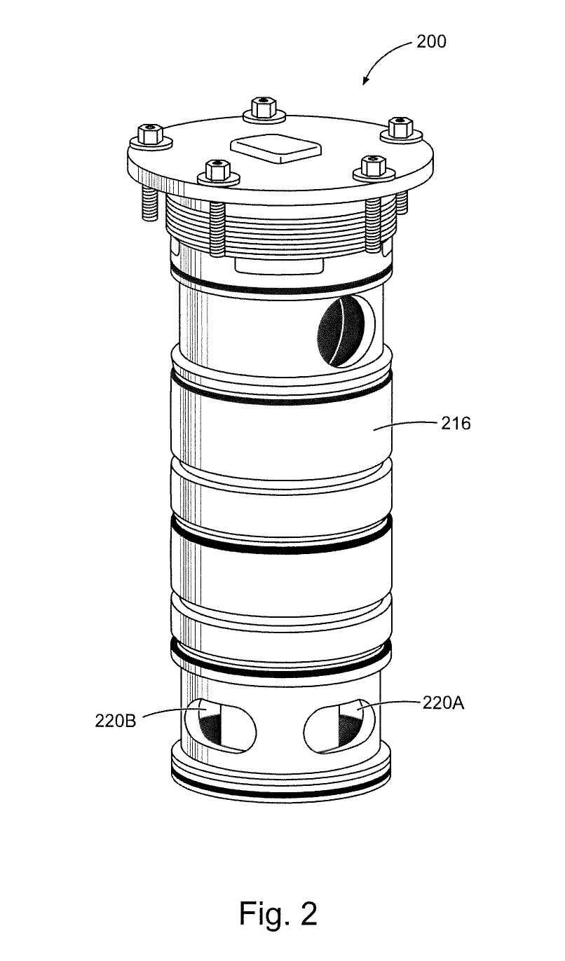

In the embodiment of FIG. 1A, the cage 116 is generally cylindrical and defines various holes. The holes include supply hole 118 and return hole 120 that correspond to the supply port 108 and the return port 110, respectively. Although FIG. 1A depicts only one supply hole 118 and one return hole 120, the valve cage 116 may include multiple supply holes and return holes arranged around the cage. For example, FIG. 2 is an isometric view of a sub-plate mounted valve 200 including a cage 216 that defines multiple return holes, including return holes 220A, 220B. Accordingly, the specific number and location of the supply holes and the return holes may vary across different embodiments.

Returning to FIG. 1A, the valve body 114 may also include a valve cap 122. Generally, the valve cap 122 is coupled to the cage 116 and retains the internal components of the valve 100. Although the valve cap 122 and cage 116 are depicted in FIG. 1A as being two separate components, in other embodiments, the valve cap 122 may be integrally formed with the cage 116.

In reference to FIG. 1A, the valve 100 may be retained within the valve pocket 104 by a locking plate 134. The locking plate 134 may be coupled to the manifold 102 by a series of bolts 136A, 136B, or any other suitable fastener. A locking nut 138 and a slip ring 140 may also be used to install the valve 100 within the valve pocket 104. As will be discussed in more detail later in this disclosure, the locking nut 138 and slip ring 140 permit rotational movement of the valve 100 within the valve pocket 104 before installation of the locking plate 134 such that the valve 100 can be properly aligned with the various ports of the manifold 102.

A spool 123 is disposed within the valve body 114. Generally, the spool 123 is a hollow elongate body movable along a linear axis of the valve body 114 between a closed and an open position. The closed and open position are depicted in FIGS. 1A and 1B, respectively. The spool 123 is movable between the open and closed positions by applying pressure to a piston 126. The piston 126 is disposed on an outside surface of the spool 123 and seals against an inside surface of the cage 116. Although the piston 126 and the spool 123 are depicted as two separate components of valve 100 in the embodiment depicted in FIGS. 1A and 1B, in other embodiments, the piston 126 and the spool 123 may be integrally formed.

Sub-plate mounted valves in accordance with this disclosure may also include a spring for biasing the spool in one of the open and closed positions. For example, in the embodiment depicted in FIGS. 1A and 1B, a spring 130 for biasing the spool 123 is disposed within chamber 124A. The spring 130 exerts a force on the piston 126 such that the piston 126 and the spool 123 are biased into the open position, shown in FIG. 1B. In other embodiments, a spring may instead be inserted into chamber 124B such that the spring biases the piston 126 and spool 123 into the closed position. Although the spring 130 of FIGS. 1A and 1B is depicted as a single helical coil spring, other embodiments in accordance with this disclosure may include any suitable number of springs of any suitable spring type. The valve body 114 also includes seals 132A and 132B that seal against the outside surface of the spool 123 at opposite ends of the valve body 114. The piston 126 and seals 132A and 132B define two chambers 124A and 124B. Supplying pressurized fluid through pilot port 112A into chamber 124A causes the piston 126 and spool 123 to move into the closed position, shown in FIG. 1A. Conversely, applying pressurized fluid through pilot port 112B into chamber 124B causes the piston 126 and spool 123 to move into the open position, shown in FIG. 1B.

In the closed position depicted in FIG. 1A, fluid flow is permitted between the return port 110 and the function port 106, but the spool 123 blocks flow between the supply port 108 and the function port 106 by sealing against a first valve seat 138. In the embodiment of FIG. 1A, the first valve seat 138 is depicted as a disc-shaped insert in the valve cap 122. The seal created between the spool 123 and the valve seat 138 in combination with the seal created between seal 132A and the outer surface of the spool 123, prevents fluid at the supply port 106 from passing through the valve 100 to the function port 106. Additionally, the spool 123 is configured such that in the closed position, the spool 123 permits flow between the return port 110 and the function port 106.

In the open position depicted in FIG. 1B, fluid flow is permitted between the supply port 108 and the function port 106, but the spool 123 blocks flow between the return port 110 and the function port 106 by sealing against a second valve seat 140. In the embodiment of FIG. 1B, the second valve seat 140 is depicted as a washer-like ring disposed opposite the first valve seat 138. The seal created between the spool 123 and the second valve seat 140 in combination with the seal created between seal 132B and the outer surface of the spool 123, prevents fluid from passing between the function port 106 and the return port 110. However, the open position permits fluid flow between the supply port 108, through the spool 123, and to the function port 106 via a hole 142 defined in the second valve seat 140.

Although the first valve seat 138 and the second valve seat 140 are each depicted in FIGS. 1A and 1B as sealing against end faces of the spool 123, other embodiments may include alternative sealing arrangements. For example, in certain embodiments either valve seat may instead be a cylinder-type seal that seals around the outside surface of the spool 123.

One of ordinary skill in the art having the benefit of this disclosure will appreciate that the above description regarding the open and closed position of valve 100 may be modified to accommodate different arrangements of the supply port 108 and the return port 110. For example, in embodiments in which the locations of the supply port and the return port are reversed, the open position described above more accurately describes a closed position, i.e., a position in which the valve permits flow between the return port and the function port while preventing fluid flow between the supply port and the function port.

FIG. 2 depicts an isometric view of a sub-plate mounted valve 200 that is not installed in a valve pocket. The valve 200 includes a valve body including a cage 216. The cage 216 defines a supply hole 208 and a plurality of return holes 210A, 210B To improve efficiency of flow through the valve, the supply hole 208 and return holes 210A, 210B are generally aligned with corresponding supply and return ports of the manifold in which the valve 200 is installed. Although misalignment between the holes of the cage and the ports of the manifold can create unnecessary restrictions to flow through the valve, leading to unnecessary pressure losses, proper alignment of sub-plate mounted valves is often complicated by the fact that the manifold ports and holes of the cage are not visible when the sub-plate mounted valve is installed within a valve pocket. Accordingly, certain embodiments may include features for assisting an operator in properly aligning the cage holes and manifold ports during installation.

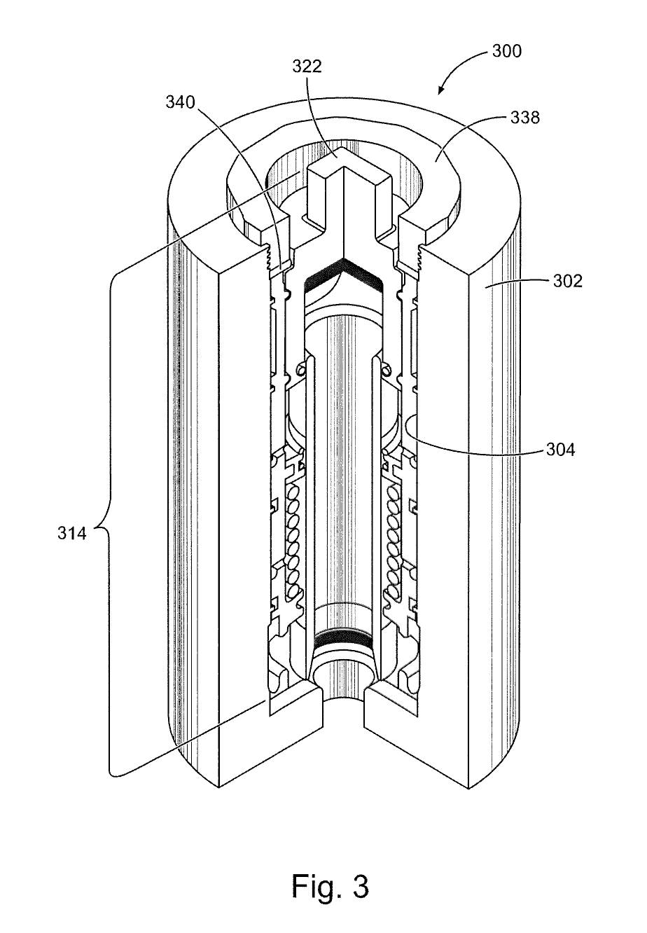

FIG. 3 depicts an isometric cutaway of a sub-plate mounted valve 300 partially installed in a valve pocket 304 of a manifold 302. Specifically, the sub-plate mounted valve 300 has been inserted into the valve pocket 304, but a locking plate is yet to be installed. The valve body 314 includes a valve cap 322 that extends partially out of the valve pocket 304.

The valve 300 is retained within the manifold by a lock nut 338. In the embodiment depicted in FIG. 3, the lock nut 338 is threaded into the top of the valve pocket 304. When the lock nut 338 is threaded in place, the valve body 314 is prevented from moving along the longitudinal axis of the valve pocket 304. However, because the lock nut 338 does not engage the valve body 314 itself, the valve body 314 may still be rotated within the valve pocket 304 to properly align the valve 300 with ports of the manifold 302. The valve cap 322 may be shaped to be gripped by hand or a tool in order to facilitate rotation of the valve body within the valve pocket 304. For example, the valve cap 322 is depicted as having a rectangular protrusion that may be used to grip the valve body 314. To minimize friction between the lock nut 338 and the valve body 314, a slip ring 340 composed of a low friction material may also be inserted between the lock nut 338 and the valve body 314.

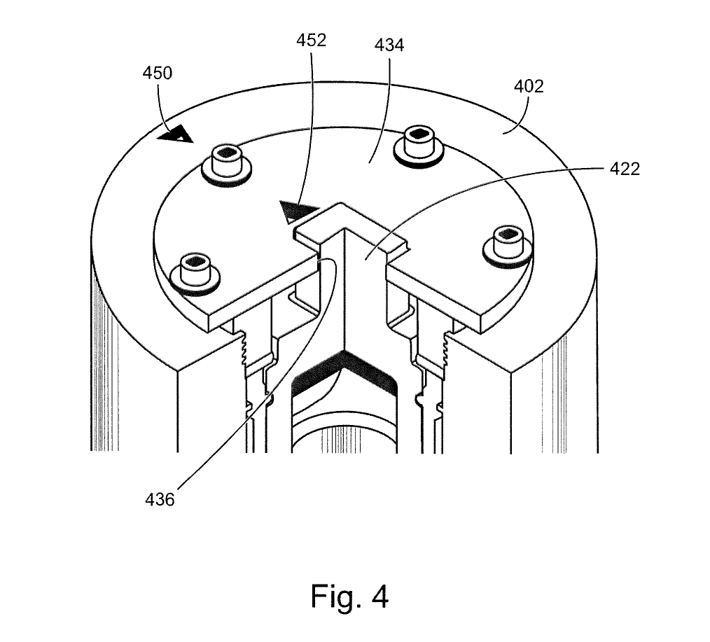

In certain embodiments, proper alignment of the valve within the valve pocket may be further facilitated by indicators placed on the manifold, the locking plate, and/or the valve cap. For example, FIG. 4 depicts a sub-plate mounted valve installed in a valve pocket of a manifold 402. The manifold includes a port indicator 450 for indicating the location of ports within the manifold 402.

In reference to FIG. 4, the sub-plate mounted valve may be retained within the manifold 402 by a locking plate 434. The locking plate 434 includes a cutout 436 shaped to receive a portion of valve cap 422, the valve cap 422 being part of a valve body disposed within the valve pocket. Due to the rectangular shape of the cutout and the valve cap 422, the locking plate 434 prevents the valve body from rotating within the valve pocket when the locking plate 434 is bolted to the manifold 402. The locking plate also includes a hole indicator 452 for indicating the location of supply and return holes of the valve body. As a result, when the locking plate 434 is installed such that the hole indicator 452 aligns with the port indicator 450, the ports of the manifold and the holes of the valve will be similarly aligned.

Although FIG. 4 depicts the manifold 402 having a single port indicator 450 and the locking plate 434 having a single hole indicator 452, embodiments are not limited to this arrangement. Either of the manifold and the locking plate may include multiple indicators for indicating other features of the manifold and valve. For example, in embodiments in which the supply port and the return port are not placed on the same side of the valve pocket, separate indicators may be used to identify the location of the supply port and the return port. Multiple hole indicators may similarly be used to indicate the location of supply and return holes of the valve. As an alternative to including a marker on the top of the locking plate, certain embodiments may instead place the indicator or indicators on the valve cap 422. Similarly, the shape of the valve cap itself may be used to indicate the location of the valve supply or return holes.

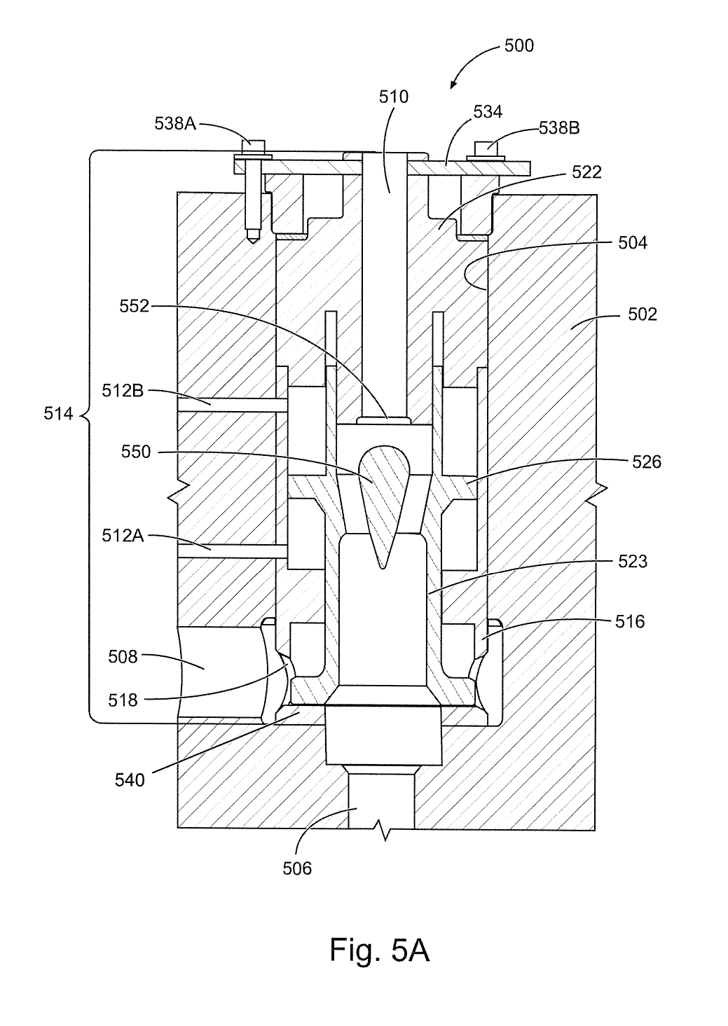

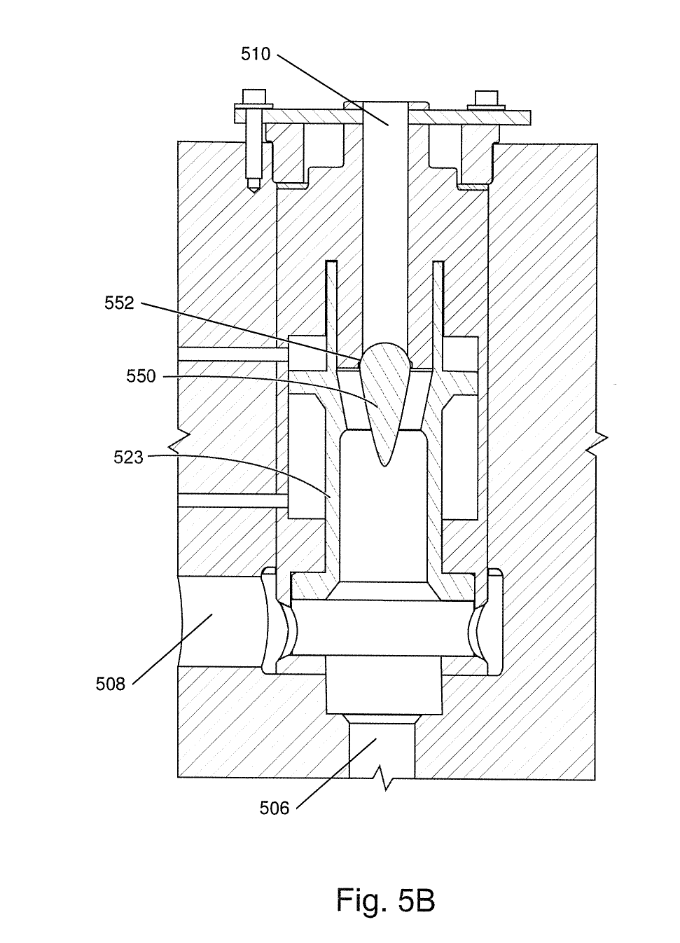

FIGS. 5A and 5B depict an alternate arrangement for a sub-plate mounted valve 500 in accordance with this disclosure. Referring to FIG. 5A, the valve 500 is installed in a valve pocket 504 of a manifold 502. The manifold 502 includes a function port 506, a supply port 508, and two pilot ports 512A, 512B.

The valve 500 includes a valve body 514 comprising a cage 516 and a valve cap 522. The cage 516 defines a supply hole 518 corresponding to the supply port 508. The valve cap 522 is coupled to the cage 516 and defines a return port 510. The return port 510 may be connected to a broader hydraulic circuit and the valve cap 522 may include threads, flanges or other suitable means for connecting the return port 510 to the hydraulic circuit.

Similar to previously discussed embodiments, the valve 500 may be retained within the valve pocket 504 by a locking plate 534 and bolts 536A, 536B. The locking plate 534 may include a cutout for receiving a portion of the valve cap 522. The valve 500 may also include indicators, a slip ring 540, and a locking nut 538 to assist in aligning the valve 500 within the valve pocket 504.

Similar to earlier discussed embodiments, a spool 523 is disposed within the valve body 514. The spool 523 is movable between a first and a second position by supplying pressurized fluid through pilot ports 512A, 512B into corresponding chambers 524A, 524B. As pressurized fluid enters chambers 524A, 524B, it acts on a piston 526 disposed on an outside surface of the spool 523, causing the spool 523 to move between the first and the second position.

In the first position, depicted in FIG. 5A, fluid flows between the function port 506 and the return port 510 defined by the valve cap 522. While in the first position, the spool 523 also seals against a valve seat 540 preventing flow between the supply port 508 and the function port 506. In the second position, depicted in FIG. 5B, the spool 523 is positioned to permit flow between the supply port 508 and the function port 506, but to prevent flow between the return port 510 and the function port 506. To prevent flow between the return port 508 and the function port 506 when the spool 523 is in the second position, a plug 550 seals against a valve seat 552 of the return port 508.

In the embodiments of FIGS. 5A and 5B, the plug 550 is a tapered plug. However, in other embodiments, the plug 550 may be of any suitable shape for sealing against the valve seat 552. For example, the plug may be a polished bearing, or disc.

Similar to the previously discussed embodiments, a spring may also be inserted between the valve body 514 and the spool 523 such that the spring biases the spool 523 into one of the first and the second position.

One of ordinary skill in the art having the benefit of this disclosure would appreciate that the locations of the supply and return port as shown in FIGS. 5A and 5B may be reversed. Specifically, the supply port may be defined by the valve cap and the return port may be defined by the manifold.

While numerous characteristics and advantages of embodiments of the present disclosure have been set forth in the foregoing description and accompanying figures, this description is illustrative only. Changes to details regarding structure and arrangement that are not specifically included in this description may nevertheless be within the full extent indicated by the claims.

What is claimed is:

1. A sub-plate mounted valve, comprising:
a valve body, the valve body comprising:
a cage defining a supply hole, a return hole, and a function hole, and
a valve cap coupled to the cage,
a valve spool disposed within the valve body, the valve spool being movable along a longitudinal axis of the valve body between a first position wherein fluid can flow between the supply hole and the function hole, and a second position wherein a fluid can flow between the return hole and the function hole; and
a piston disposed on an outer surface of the valve spool operable to move the valve spool between the first and the second position when pressure is applied to the piston.

2. The sub-plate mounted valve of claim 1, further comprising
at least one spring disposed between the cage and valve spool, wherein the at least one spring biases the valve spool towards one of the first position and the second position.

3. The sub-plate mounted valve of claim 1, wherein:
the valve spool is integrally formed with the piston.

4. The sub-plate mounted valve of claim 1, wherein:
the piston is coupled to the valve spool.

5. The sub-plate mounted valve of claim 1, further comprising:
a locking nut suitable for retaining the valve body within a valve pocket, the locking nut positioned adjacent to the valve cap;
a slip ring disposed between the valve cap and the locking nut; and
a locking plate shaped to receive at least a portion of the valve cap, said locking plate operable to maintain the valve body in a fixed position within the valve pocket when the locking plate is coupled to the valve pocket.

6. The sub-plate mounted valve of claim 1, further comprising:
an indicator that indicates a location of at least one of the supply hole and the return hole, wherein the indicator remains visible when the sub-plate mounted valve is installed in a valve pocket.

7. The sub-plate mounted valve of claim 6, wherein:
one of the locking plate and the valve cap comprises the indicator.

8. A manifold assembly, comprising:
a manifold block having
a valve pocket,
a supply port,
a return port, and
a function port; and
a sub-plate mounted valve installed in the valve pocket, the sub-plate mounted valve, comprising:
a valve body, the valve body further comprising:
a cage defining a supply hole for fluid flow between the valve body and the supply port, a return hole for fluid flow between the valve body and the return port, and a function hole for fluid flow between the valve body and the function port, and
a valve cap coupled to the cage,
a valve spool disposed within the valve body, the valve spool being movable along a longitudinal axis of the valve body between a first position wherein fluid can flow between the supply hole and the function hole, and a second position wherein fluid can flow between the return hole and the function hole; and
a pilot-operated piston disposed on the outer circumference operable to move the valve spool between the first and second position when pressure is supplied.

9. The manifold assembly of claim 8, wherein:
the manifold further comprises a port indicator corresponding to at least one of the supply port and the return port; and
the sub-plate mounted valve further comprises a hole indicator corresponding to at least one of the supply hole and the return hole, wherein:
alignment of the port indicator and the hole indicator aligns at least one of the supply port with the supply hole and the return port with the return hole.

10. The manifold assembly of claim 8, wherein:
the first pilot port and the second pilot port are positioned between the supply port and the return port.

11. The manifold assembly of claim 8, wherein:
the sub-plate mounted valve further comprises at least one spring that biases the valve spool towards one of the first position and the second position.

12. The manifold assembly of claim 8, wherein:
the valve spool is integrally formed with the at least one pilot-operated piston.

13. The manifold assembly of claim 8, wherein:
the pilot-operated piston is coupled to the valve spool.

14. The manifold assembly of claim 9, further comprising:
a locking nut suitable for retaining the valve body within the valve pocket, the locking nut positioned adjacent to the valve cap;
a slip ring disposed between the valve cap and the locking nut; and
a locking plate shaped to receive at least a portion of the valve cap such that when the locking plate is coupled to the valve pocket and receives the portion of the valve cap, the valve body is maintained in a fixed position within the valve pocket.

15. The manifold assembly of claim 14, wherein:
one of the locking plate and the valve cap comprises the hole indicator.

16. A sub-plate mounted valve, comprising:
a valve body, the valve body comprising:
a cage defining a first passage, and a function hole, and
a valve cap coupled to the cage, the valve cap defining a second passage.
a valve spool disposed within the valve body, the valve spool being movable along a longitudinal axis of the valve body between a first position wherein fluid can flow between the first passage and the function hole, and a second position wherein a fluid can flow between the second passage and the function hole; and
a piston disposed on an outer surface of the valve spool operable to move the valve spool between the first and the second position when pressure is applied to the piston.

17. The sub-plate mounted valve of claim 16, wherein:
the valve spool comprises a plug that seals against the second passage when the valve spool is in the first position.

18. The sub-plate mounted valve of claim 17, wherein:
the plug is selected from the group of a tapered plug, a disc, and a polished bearing.

19. The manifold assembly of claim 16, further comprising:
at least one spring disposed between the cage and valve spool, wherein the at least one spring biases the valve spool towards one of the first position and the second position.

20. The sub-plate mounted valve of claim 16, further comprising:
a locking nut suitable for retaining the valve body within a valve pocket, the locking nut positioned adjacent to the valve cap;
a slip ring disposed between the valve cap and the locking nut; and
a locking plate shaped to receive at least a portion of the valve cap, said locking plate operable to maintain the valve body in a fixed position within the valve pocket when the locking plate is coupled to the valve pocket.
